(19) United States
(12) Patent Application Publication
(10) Pub. No.: US 2006/0289183 A1
(43) Pub. Date: Dec. 28, 2006

(54) Hand-held power tool with damping system

(76) Inventor: Alfred Schreiber, Kirchheim (DE)

Correspondence Address: ST. ONGE STEWARD JOHNSTON & REENS, LLC, 986 BEDFORD STREET, STAMFORD, CT, 06905-5619, US

(21) Appl. No.: 11/471,837

(22) Filed: Jun. 21, 2006

(30) Foreign Application Priority Data
Jun. 24, 2005 (DE) 10 2005 031 074.5

(51) Int. Cl. B25D 17/00

(52) U.S. Cl. 173/162.2

(57) ABSTRACT

A hand-held power tool, in particular an electric tool is disclosed, comprising a housing in which a motor is received for driving a tool, further comprising a damping system for actively influencing the vibration behavior, wherein the damping system comprises at least one damping element and a sensor that emits an electric sensor signal when deformation occurs, which signal is supplied to an electric circuit that generates therefrom a control signal which is supplied to an actor at a given phase angle relative to the sensor signal.

### BACKGROUND OF THE INVENTION

The present invention relates to a hand-held power tool, in particular an electric tool, having a housing in which a motor is received for driving the tool, and a damping system for damping vibrations.

Hand-held power tools, in particular electric tools, have been in use for more than hundred years and are used in numerous different configurations. All configurations have in common that a motor intended to drive the tool is received in a housing. In some cases, mechanical oscillations in the form of vibrations occur during operation. Whether or not, and with what strength, vibrations occur depends of course on the respective machining process, the material being worked, the tool and other influencing factors. Still, in many cases vibrations cannot be avoided and may have detrimental effects on the working result or may be experienced by the user as disagreeable. In some cases, for example in the case of percussion drills, one therefore has used additional handles in the form of stud handles provided with mechanical damping elements such as rubber elements or the like.

Such damping elements cannot, however, achieve an effective reduction of vibrations, or else guidance of the hand tool would become so inaccurate that the precision of work would suffer quite considerably.

### SUMMARY OF THE INVENTION

It is a first object of the present invention to disclose a hand-held power tool which is equipped with an effective damping system for damping vibrations.

It is a second object of the invention to disclose a hand-held power tool which allows an active damping of particular mechanical disturbances, in particular vibrations.

It is a third object of the invention to disclose a hand-held power tool which allows an adjustable damping of vibrations.

It is a fourth object of the invention to disclose a hand-held power tool which allows an active damping of particular mechanical disturbances without the aid of external energy.

It is a fifth object of the invention to disclose a hand-held power tool which allows an active damping of vibrations at selected positions of the power tool.

It is a sixth object of the invention to disclose a hand-held power tool having an efficient damping of vibrations even when configured in a variety of different forms, such as in a pistol shape, in elongated bar shape, or a shape of a two-handed angle grinder.

It is a seventh object of the invention to disclose a hand-held power tool which allows to store for a subsequent retrieving some kind of value characteristic for vibrations that occur during operation.

These and other objects of the invention are achieved according to the invention by a hand-held power tool, in particular an electric tool, having a housing in which a motor is received for driving a tool, and a damping system for actively damping vibrations, which comprises at least one damping element with a sensor that emits an electric sensor signal when deformation occurs, which signal is then supplied to an electric circuit that generates therefrom a control signal which is supplied to an actor at a given phase angle relative to the sensor signal.

The object of the invention is thus perfectly achieved.

The invention permits the vibration behavior of a tool to be selectively influenced. The damping behavior can be adapted to the respective field of application within broad limits.

Vibrations that are disagreeable or physiologically detrimental to a user of the electric tool can be reduced in this way.

The damping system preferably is provided with at least one sensor and at least one actor responding to such sensor.

However, the sensor and the actor may also be combined to a single component.

According to a further embodiment of the invention, the damping system comprises at least one piezoelectric transducer element, one piezomagnetic transducer element, one antiferroelectric transducer element, one electrostatic transducer element, one magnetostrictive transducer element or one deformation memory transducer element.

Generally, all known kinds of sensor elements and actor elements would be imaginable that convert mechanical energy to electric energy or electric energy to mechanical energy.

Further, strain gauges, micro pressure sensors, polymeric sensors or composite sensors, such as composite fiber sensors, for example, may also be used as sensor elements.

According to a further embodiment of the invention, the damping system comprises at least one nanotube element, preferably a carbon nanotube element.

When nanotubes, in particular carbon nanotubes are used, considerably higher forces can be produced by the actor than in the case of conventional polymeric or piezo actuators. Further, carbon nanotubes can be operated at a very low supply voltage, while polymeric actors and piezo actors require supply voltages of up to several hundred volts.

The nanotube elements used in this case may comprise at least one layer with single or multi-wall carbon nanotubes or nanotubes made from other organic components, such as BN, MOS₂ or V₂O₅.

All in all, the use of nanotube actors allows considerably reduced response characteristics and more effective damping to be achieved, as compared with the usual actors known in the art.

According to a further embodiment of the invention, the electric circuit comprises means for deriving from the sensor signal a value characteristic of the vibrations of the electric tool, which can then be supplied to a memory.

It is thereby possible to detect and store the vibrations with a view to objectively recording the vibration values encountered during operation of the respective hand-held power tool so as to use them for control purposes. It is thus possible to realize a “vibration dosimeter”. To the extent desired for the respective application, certain weighing procedures may also be applied in this case depending on the respective frequencies and amplitudes.

Characteristic values for the vibration behavior of the hand-held power tools may also be used to define maintenance intervals, for example time schedules for the exchange or overhaul of bearings or of the brushes of an electric motor.

According to a further embodiment of the invention, the electric circuit comprises a microprocessor.

Such a configuration permits an in particular effective reduction of vibrations to be achieved and at the same time a simple structure that can be adapted to the particular application by suitable software. Given the fact that microprocessors are anyway used in many power-operated tools, an existing microprocessor control may be correspondingly adapted to the particular tool and also to its particular use.

The phase-shifted control signal may be selected, as a function of the particular application, in such a way that vibrations are practically suppressed in full or else are reduced to a degree that is acceptable for the respective operation.

It is also possible in this case to produce a phase-shifted control signal that occurs ahead of the sensor signal.

Further, the electric circuit may comprise a microprocessor controlled by a self-learning algorithm processing a signal sequence generated by said sensor signal within a given time frame for generating a control signal fed to said actor for optimizing the reduction of vibrations.

According to a further embodiment of the invention, a damping element is received in at least one area of the housing of the hand-held power tool so that the stiffness of the housing is selectively and locally influenced by such damping system.

It is thus possible to achieve greater stiffness of the housing or else greater resilience at other points of the housing in order to improve the general vibration behavior.

According to a further embodiment of the invention, at least one damping system is configured in planar, in particular in strip-like shape.

This permits in particular easy mounting of the element on any part of the housing.

The term “damping system” is meant in this case to include any mechanical/electric or electric/mechanical transducer element, it being understood that the latter may consist of a single component acting as sensor and actor, or of two separate elements for the sensor and the actor, respectively, that are mounted directly adjacent one to the other or are physically joined one to the other.

According to a further embodiment of the invention, the hand-held power tool comprises at least two functional elements selected from the group of one motor unit, one gear unit and one grip unit, with at least one damping element being arranged in the area of a joint between two functional elements.

This permits in particular effective damping of vibrations regardless of the particular design of the respective tool. In particular effective damping is rendered possible in this way in the area of the joints between different functional elements, which transmit mechanical energy.

It has been found that the critical points through which the generation of vibrations, and their increase or reduction, can be influenced most effectively, lie in the areas of the joints between the different functional elements. Therefore, vibrations can be most effectively reduced if the damping elements are arranged exactly in those areas, for example between the motor unit and the gear unit or between the grip unit and the gear unit, or between the motor unit and the grip unit.

According to a further configuration of the invention, at least one damping element is arranged in the area of a motor bearing.

Any propagation of vibrations that may be caused by the electric motor as such is thereby counteracted most effectively.

According to a further embodiment of the invention, at least one damping element is received on an inside or an outside of the housing.

The damping elements may be mounted in this case directly on a surface of the housing, and may be received in suitably shaped recesses, or may be connected with the surfaces in some other way, for example by bonding or molding processes, etc.

According to a further embodiment of the invention, at least one damping element is received on a handle projecting from the housing, in particular on a stud handle. In this case the damping element preferably is arranged in the area of the joint between the handle and the remaining portion of the housing.

According to a further embodiment of the invention, the electric energy necessary for operation of the electric circuit is derived from the vibration energy to which the damping element is exposed.

Such an embodiment is of special advantage where the damping element is arranged in a unit that can be detached from the housing, for example in a handle in the form of a stud handle, which is detachably mounted on the housing. Such an arrangement is of like advantage for battery-driven machines and pneumatically-driven machines.

According to a further embodiment of the invention, an external energy source is provided for supply of the electric circuit.

With such a configuration it is even possible to guarantee a clearly more effective damping behavior and particularly purposeful adaptation of the damping behavior to the most different requirements.

According to a further embodiment of the invention, the housing is configured as a pistol housing having an elongated housing element, in which the motor is received, and a pistol grip, with at least one damping element being provided in the transition area between the pistol grip and the elongated housing element.

This permits the vibration behavior of the housing to be influenced in an in particular effective way.

According to a further configuration of the invention, the housing is designed as a pistol housing having an elongated housing element, in which the motor and a gearbox are received, and a pistol grip, with at least one damping element being arranged in the transition area between the motor and the gearbox.

So, the vibration behavior can be influenced in particular effectively also in cases where the hand-held power tool comprises a gearbox in addition to the motor.

According to a further configuration of the invention, the hand-held power tool is configured in bar shape, for example as an angle grinder, having an elongated housing element, in which the motor is received, and a gearhead in which a gearbox is received, with at least one damping element being provided in the area of the joint between the gearhead and the elongated housing element.

According to a further variant of the invention, where the hand-held power tool is likewise designed in bar shape, for example as an angle grinder, at least one damping element is provided on the elongated housing element in the area of an end of the motor opposite the gearhead.

Such a design allows vibrations to be influenced in particular effectively when the tool is designed as an angle grinder.

According to a further configuration of the invention, the housing comprises a main housing element, which is connected with a grip via webs, with at least one damping element being provided in the area of the webs.

Such a design of a hand-held power tool likewise permits the vibration behavior to be influenced in particular effectively.

It is understood that the features of the invention mentioned above and those yet to be explained below can be used not only in the respective combination indicated, but also in other combinations or in isolation, without leaving the scope of the invention.

### BRIEF DESCRIPTION OF THE DRAWINGS

Further features and advantages of the invention will become apparent from the description that follows of a preferred embodiment of the invention, with reference to the drawing. In the drawings:

FIG. 1 shows a perspective view of a first embodiment of a power-operated hand-held power tool in the form of an angle grinder;

FIG. 2 shows a schematic representation of one possible superposition of sensor signal and control signal;

FIG. 3 shows a simplified representation of one possible arrangement of a damping system according to the invention using a microprocessor;

FIG. 4 shows a schematic representation of another embodiment of a damping system according to the invention, which functions without any external energy supply;

FIG. 5 a schematic representation of a further embodiment of a damping system according to the invention with external energy supply;

FIG. 6 shows a schematic representation of a further embodiment of a hand-held power tool according to the invention;

FIG. 7 shows a diagrammatic side view of a further embodiment of a hand-held power tool according to the invention;

FIG. 8 shows a simplified section through the hand-held power tool according to FIG. 7, taken along line VIII-VIII; and

FIG. 9 shows an embodiment of a hand-held power tool according to the invention, modified with respect to the configuration illustrated in FIG. 8, with a different arrangement of the damping element.

### DETAILED DESCRIPTION OF THE PREFERRED EMBODIMENTS

FIG. 1 shows a perspective side view of a hand-held power tool 10 according to the invention, designed as an angle grinder. The hand tool 10 comprises a housing 12, the forward end of which is connected to a gear case 14 and the rear end of which carries a grip element 16. A motor 24 in the form of a universal motor, received inside the housing 12 in the area of the joint to the gear case 14, is coupled with a right-angle gear (not shown), the output shaft 27 of which is capable of driving a tool 20 in the form of a grinding wheel. The tool 20 is enclosed in part in the known manner by a protective cover 22. A stud handle 18 is additionally screwed onto the side of the gear case 14.

An angle grinder of a design generally known as such is configured as a two-hand angle grinder for being gripped by the stud handle 18 by a first hand and by the grip portion 16 by a second hand. The invention now proposes at least one damping system by which vibrations occurring in operation can be damped effectively.

To this end, two damping elements 30, 31 are mounted in the transition area between the motor 24 and the gear 26 received in the gear case 14. Further, two additional damping elements 32, 33 are provided in the transition area between the motor 24 and the grip portion 16 adjoining the latter, or in the transition area between the motor 24 and an electronics module 28 adjoining the latter.

Such damping elements 30 to 33, in cooperation with a suitable electric circuit that will be described further below, serve to actively dampen possible vibrations.

Using the damping elements 30 to 33, a sensor signal is produced which is approximately proportional to a mechanical influence (for example a vibration) acting on the respective damping element.

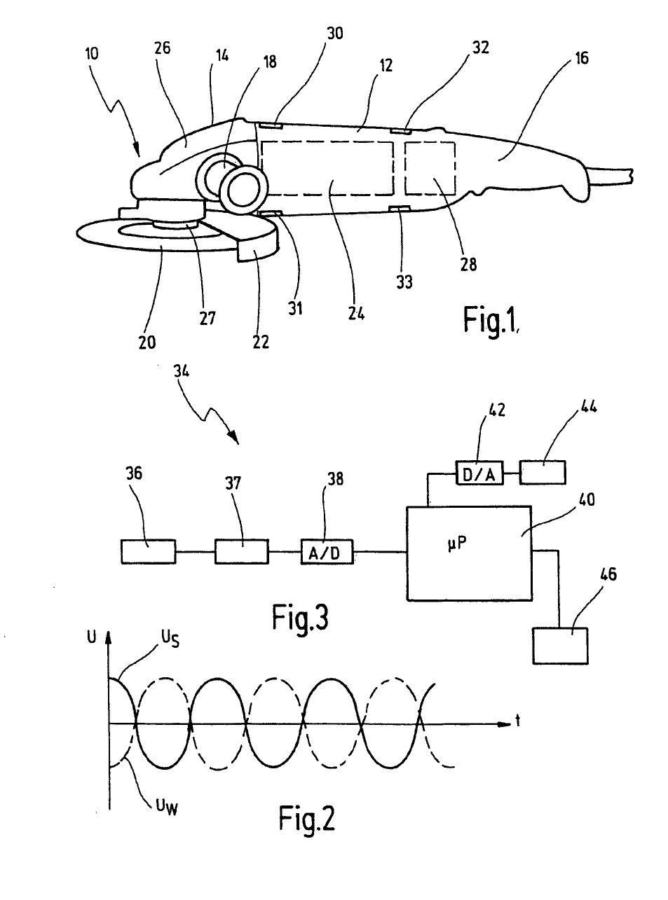

In FIG. 2, such a signal is illustrated diagrammatically as an approximately sinusoidal signal Uₛ for a certain period of a vibration occurring during a machining process.

Using a suitable electric circuit, a phase-shifted control signal is generated from that sensor signal Uₛ which is then fed back to the damping elements 30 to 33. Such a phase-shifted signal is illustrated diagrammatically as U_{w} in FIG. 2. In the case of a periodic signal, complete canceling can be achieved with a signal of equal amplitude, but phase-shifted by 180°.

Depending on the phase angle between the sensor signal Uₛ and the control signal U_{w}, the amplitude ratio between the two signals, the mechanical coupling between the damping elements 30 to 33 and the respective housing elements and other influencing variables, mechanical vibrations to which the housing is exposed can be selectively influenced.

It is in fact imaginable to cancel vibrations almost completely. In many cases, however, the vibrations will be dampened to a certain degree only.

An example of a suitable control circuit can be seen in the diagrammatic representation of a damping system 34 in FIG. 3.

In this case, a mechanical vibration is detected by a sensor 36, the signal is initially amplified in an analog way by an amplifier 37 and is then converted to a digital signal by an analog-to-digital converter 38. The digitalized sensor signal is supplied to a microprocessor 40. The microprocessor 40 then generates from that signal a phase-shifted signal, based on a suitable control algorithm, which signal is converted back to an analog signal by a digital-to-analog converter 42, for being supplied to an actor 44.

The sensor 36 and the actor 44 may be separate components, which preferably are arranged in direct neighborhood one to the other for permitting effective damping of vibrations, for example. In FIG. 1, the sensor 36 and the actor 44 are illustrated together as “damping elements” although as a rule such elements will be arranged in immediate neighborhood one to the other or will be physically combined. However, it cannot be excluded that in certain special cases the respective sensor and the respective actor may be arranged physically remote one from the other. Combining the sensor and the actor in a single component is likewise possible.

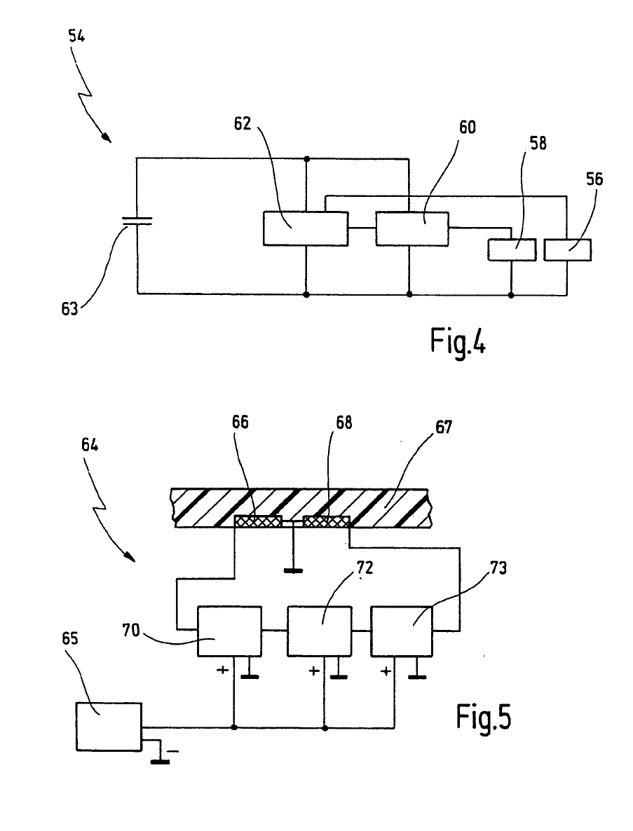

In FIG. 4, one possible configuration of a damping system according to the invention is indicated generally by reference numeral 54.

The damping system 54 in question functions without any external energy supply, which is of particular advantage in cases where the respective damping system is to be integrated in a detachable element, such as a detachable handle.

Electric energy is generated in the damping system 54 by an actor 58 which reacts to mechanical deformation. The electric energy is coupled into a bidirectional amplifier 60 which may consist of a switching amplifier, for example. The amplifier 60 is connected to an electronic control unit and to a memory element 63, for example a capacitor. The amplifier 60 serves for amplifying electric signals supplied by the actor 58 and for storing the energy gained in the memory element 63. Similarly, the amplifier 60 serves to amplify signals received from the control electronics 62 and to feed them again into the actor 58. In the case of the described configuration, a sensor 58 is arranged in the immediate neighborhood of the actor 58 and is connected to the input of the control electronics 62.

Mechanical interference signals (vibrations) sensed by the sensor 56 produce a sensor signal from which a phase-shifted control signal is derived by the control electronics 62, which is then supplied to the actor 58 in order to cause the latter to dampen the mechanical vibration.

When properly sized, damping of the mechanical output signal to approximately 30% of its initial value can be achieved without any external energy supply.

For example, the actor 58 may be a piezoelectric transducer element, a piezomagnetic transducer element, an antiferroelectric transducer element, an electrostatic transducer element, a magnetostrictive transducer element, a deformation memory transducer element, a piezoceramic transducer element, or a nanotube element, preferably a carbon nanotube element.

In principle, all kinds of known transducer elements would be imaginable that convert electric energy to mechanical energy and vice versa.

In particular preferred are nanotube elements that comprise at least one layer of single or multi-wall carbon nanotubes or nanotubes that consist of other organic components, such as BN, MoS₂ or V₂O₅.

Compared with other known actors, carbon nanotubes permit clearly higher sensitivities to be achieved at lower voltages (for example compared with piezo elements).

The sensor 56 may have a structure identical to that of the actor 58. It may, however, also be a sensor of different structure, for example a strain gauge, a micro pressure sensor, a polymeric sensor, an acceleration sensor or a senor of another suitable kind.

FIG. 5 shows another embodiment of a damping system 64 according to the invention, with external energy supply.

A sensor 66 and an actor 68 are provided in direct neighborhood one to the other on a housing element 67. The output signal of the sensor 66 is coupled to an amplifier 70 whose output is connected with control electronics 72. The control electronics 72 generate a phase-shifted control signal which is supplied to an amplifier 73 which latter emits an amplified signal to the actor 68. The control signal is phase-shifted to a certain degree relative to the sensor signal in order to achieve damping of a vibration that acts on the housing element 67. The electronic components 70, 72, 73 are supplied with voltage via an external voltage supply 65 which may be part of the voltage supply of a control anyway provided. As a rule, the use of an active voltage supply offers advantages over an autonomous arrangement as illustrated in FIG. 4, as in this case vibrations can be damped more effectively than in the case of a circuit according to FIG. 4.

In order to achieve effective damping of vibrations in a power-driven hand tool, such as an electric tool, it is essential to suitably select the positions of the housings where the respective damping elements, consisting either of combinations of the sensor and the actor, placed in direct neighborhood one to the other, or of a combined element, are to be positioned.

Preferably, the damping elements are arranged in such a way that they are placed either in the direct neighborhood of a possible vibration-producing source, i.e. in the area directly adjacent an electric motor, for example in the area of an armature bearing, or else in the area of the joint between different functional elements of the hand tool. The functional elements include the motor, the gearbox and the grip portion.

Consequently, the damping elements preferably are arranged between the motor and the gearbox, between the motor and the grip portion or between the gearbox and the grip portion, depending on the particular structure of the hand tool. Where additional handles are provided on the respective hand tool, the damping elements preferably are provided in the transition area between the respective handle and the housing.

The use of such arrangements permits vibrations occurring in operation of the hand tool to be reduced most effectively.

A first arrangement of that kind has been explained already with reference to FIG. 1.

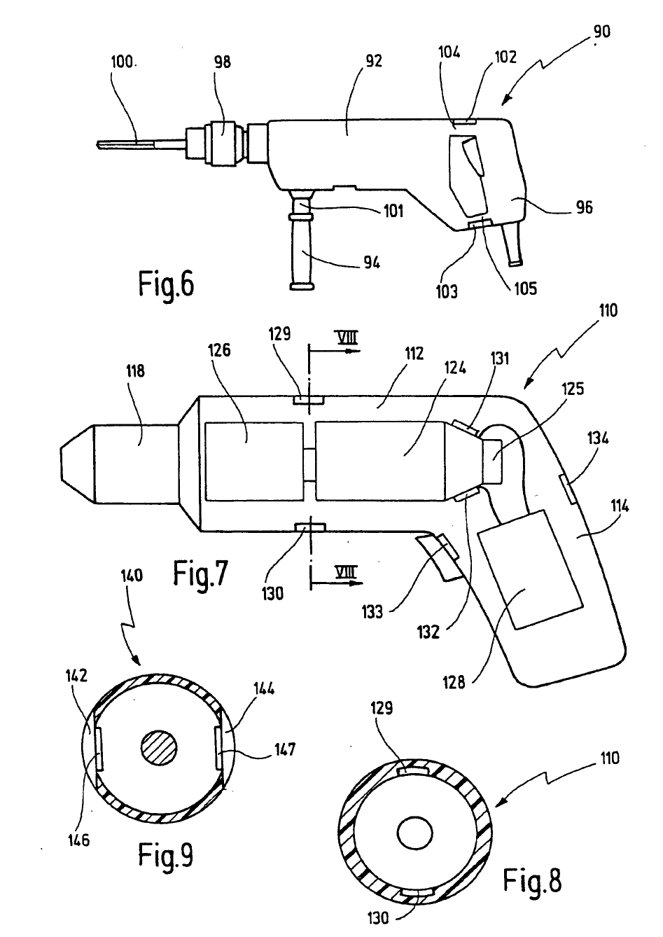

FIG. 6 shows another hand tool 90 according to the invention in the form of a hammer drill.

The hand tool 90 comprises an elongated housing 92 in which the motor and the gearbox are received.

Mounted on the forward end is a receptacle 28 in the form of a drill chuck in which a tool, such as a drill 100, may be mounted. A stud handle 94, which projects in downward direction and which is connected with the housing element 92 via a damping element 101, is provided in the lower forward portion of the housing 92. This is followed, at the end of the housing 92 opposite the receptacle 98, by a grip 96 which is connected with the housing element 92 via webs 104, 105. Inside the webs, i.e. in the transition area between the grip 96 and the housing element 92, there are once more provided damping elements 102, 103.

FIG. 7 shows one possible arrangement of damping elements in a power-operated hand tool 110 in pistol shape, for example a drilling or a screwing machine.

The hand tool 110 comprises an elongated housing portion 112 and a pistol grip 114 connected with the elongated housing portion 112. Inside the elongated housing portion 112, there is provided a motor 124 that drives a gear 126 which is finally connected, in a manner not shown in detail, with a receptacle 118 in the form of a drill chuck for driving a tool mounted in the chuck. The motor 124 comprises an armature bearing 125 at its end opposite the chuck 118 and is coupled with an electronics module 128 which may be housed in the pistol grip 114, for example.

In order to achieve effective damping of vibrations in a hand tool constructed in this way, damping elements 129, 130 are provided in the transition area between the motor 124 and the gearbox 126.

Moreover, additional damping elements 133, 134 are arranged in the transition area between the elongated housing portion 112 and the pistol grip 114.

Further, additional damping elements 131, 132 may be provided at the motor 124, in particular in the area of its armature bearing 125, in order to dampen vibrations that might be produced in the area of the armature bearing 125.

The damping elements as such may be received, for example, in correspondingly shaped recesses in housing portions or may be applied in planar form on the inside or the outside of the housing. The connection with the respective housing portion preferably is achieved by bonding or by another material connection which can be realized, for example, during molding of a plastic housing. In any case, an intimate material connection with the respective housing portion is of advantage in order to ensure effective transmission of mechanical energy between the respective damping element and the housing portion.

FIG. 8 shows by way of example how the respective damping elements 129, 130 are set into openings in the side wall of the housing.

FIG. 9 shows by way of example and as an alternative a planar arrangement of damping elements 146, 147 on webs 142, 144 provided on the inside of the housing.

It goes without saying that the above solution is only one of many imaginable ways of mounting the damping elements.

1. A hand-held power tool, comprising:
a housing;
a motor received within said housing for driving a tool;
a damping system for actively influencing vibrations emerging from said power tool, said damping system comprising
at least one damping element having a sensor emitting an electric sensor signal in response to a deformation caused by vibrations of said power tool;
an electric circuit into which said electric sensor signal is fed for generating a control signal in response thereto; and
an actor driven by said control signal at a given phase shift relative to said sensor signal.

2. The hand-held power tool as defined in claim 1, wherein the damping system comprises at least one element selected from the group formed by a piezoelectric transducer element, a piezomagnetic transducer element, a antiferroelectric transducer element, an electrostatic transducer element, a magnetostrictive transducer element, a deformation memory transducer element and a nanotube transducer.

3. A hand-held power tool, comprising:
a housing;
a motor received within said housing for driving a tool;
a damping system for actively influencing vibrations emerging from said power tool, said damping system comprising
at least one damping element having a sensor emitting an electric sensor signal in response to a deformation caused by vibrations of said power tool;
an electric circuit into which said electric sensor signal is fed for generating a control signal in response thereto; and
an actor comprising at least one nanotube element driven by said control signal at a given phase shift relative to said sensor signal.

4. The hand-held power tool as defined in claim 1, wherein the electric circuit is configured for deriving from said sensor signal a value characteristic of vibrations of said hand tool, and further comprises a memory for storing said characteristic value.

5. The hand-held power tool as defined in claim 1, wherein said electric circuit is configured for deriving from said sensor signal a phase-shifted control signal that is timed ahead of said sensor signal.

6. The hand-held power tool as defined in claim 1, wherein said electric circuit comprises a microprocessor controlled by a self-learning software algorithm processing a signal sequence generated by said sensor signal within a given time frame for generating a control signal fed to said actor for reducing vibrations.

7. The hand-held power tool as defined in claim 1, wherein an actor is received in at least one area of said housing, the area being selected to locally influence a stiffness of said housing selectively.

8. The hand-held power tool as defined in claim 1, wherein at least one actor is configured in strip-like shape.

9. The hand-held power tool as defined in claim 1, wherein at least one sensor is configured in strip-like shape.

10. A hand-held power tool, comprising:
a housing;
a motor received within said housing for driving a tool;
a damping system for actively influencing vibrations emerging from said power tool, said damping system comprising
at least one damping element having a sensor emitting an electric sensor signal in response to a deformation caused by vibrations of said power tool;
an electric circuit into which said electric sensor signal is fed for generating a control signal in response thereto;
an actor driven by said control signal at a given phase shift relative to said sensor signal; and
at least two functional elements selected from the group formed by a motor unit, a gear unit and a grip unit, said two functional elements being connected to each other by a joint area, wherein at least one actor and at least one sensor are arranged in said joint area.

11. The hand-held power tool as defined in claim 10, wherein said housing comprises a web, whereon at least one actor is received.

12. The hand-held power tool of claim 1, wherein said motor further comprises an armature held within armature bearings received within said housing in selected regions, wherein at least one actor is arranged in close relation to said selected regions.

13. The hand-held power tool as defined in claim 1, wherein said housing comprises an inner side and an outer side, and wherein at least one actor is received on said inner side and at least one actor is received on said outer side of said housing.

14. The hand-held power tool as defined in claim 1, wherein said housing comprises a web, whereon at least one actor is received.

15. The hand-held power tool as defined in claim 1, wherein said electric circuit comprises means for generating electric energy for operating said electric circuit from vibration energy to which said hand-held power tool is exposed.

16. The hand-held power tool as defined in claim 1, wherein said housing is configured as a pistol housing comprising an elongated housing element, wherein said motor is received, and further comprises a pistol grip attached to a transition region formed between said elongated housing element and said pistol grip, wherein at least one actor is arranged within said transition region.

17. The hand-held power tool as defined in claim 1, wherein said housing is configured as a pistol housing comprising a pistol grip attached to an elongated housing element, wherein said motor and a gearbox are received within a transition region being formed between said motor and said gearbox, and wherein at least one actor is arranged in the transition region between said motor and said gearbox.

18. The hand-held power tool as defined in claim 1, wherein said housing is configured as a bar shaped housing having an elongated housing element, wherein said motor is received, and further comprises a gearhead attached to said elongated housing element and within which a gearbox is received, wherein a joint region is formed between said gearhead and said elongated housing element, and wherein at least one actor is arranged within said joint region.

19. The hand-held power tool as defined in claim 1, wherein said housing is configured as a bar shaped housing having an elongated housing element, wherein said motor is received, and further comprises a gearhead attached to said elongated housing element and within which a gearbox is received, wherein at least one actor is located on said elongated housing element in an end region of said motor opposite said gearhead.

20. The hand-held power tool as defined in claim 1, wherein said housing comprises a main housing element and a grip connected to said main housing element via webs, wherein at least one actor is attached to one of said webs.
